(19) United States
(12) Patent Application Publication
(10) Pub. No.: US 2007/0113710 A1
(43) Pub. Date: May 24, 2007

(54) Ratchet wrench

(76) Inventor: Chia Yu Chen, Taichung City (TW)

Correspondence Address: TROXELL LAW OFFICE PLLC, SUITE 1404, 5205 LEESBURG PIKE, FALLS CHURCH, VA, 22041, US

(21) Appl. No.: 11/281,494

(22) Filed: Nov. 18, 2005

(51) Int. Cl. B25B 13/46; B25B 23/16; B25G 1/00

(52) U.S. Cl. 81/60; 81/177.1

(57) ABSTRACT

A ratchet wrench includes a metal rod member, an outer layer and a grip. The outer layer surrounds an upper portion of the metal rod member, and the outer layer is combined with the grip that can be chosen from a variety of grips having different shapes, colors and patterns. The grip and the outer layer are separately made for enhancing the percentage of qualified finished products so as to lower producing cost.

### BACKGROUND OF THE INVENTION

1. Field of the Invention

This invention relates to a ratchet wrench, particularly to one having an upper portion of a rod of a metal rod member covered with an outer layer made of soft material, and a lower portion of the rod combined with a grip that is possible to be made to have different shapes or colors for lowering cost for molds and diversifying the shapes of the ratchet wrench for selection.

2. Description of the Prior Art

A conventional ratchet wrench shown in FIG. 1, includes a metal strip 1 formed by pressing, and an outer layer 2 completely surrounding the metal strip 1. The metal strip 1 is provided with a plurality of ribs 3 and holes 4, so the outer layer 2 may be combined as integral with the metal strip 1 when it is formed in a mold. Further, the outer layer 2 is made of soft material such as plastic, carbon fiber, etc, so the outer layer with some elasticity may protect the ratchet wrench from damaging a work in case of the ratchet wrench collides with the work. Moreover, the outer layer 2 may have a separating function for preventing the metal strip 1 from hurting a person by shielding static electricity on the metal strip 1.

As the conventional ratchet wrench has the metal strip 1 surrounded with the outer layer 2, the metal strip 1 has to be provided with a shaft hole 5 in a front section, and the outer layer 2 has to be provided with a hollow space 6 corresponding to the shaft hole 5 for injecting molding of the outer layer 2, and further the surrounding precision of the shaft hole 5 and the hollow space 6 are needed to be taken care of during injecting, so the mold for the outer layer 2 is rather difficult to make. Besides, the outer layer 2 has to be formed connected with a grip 7 in a lower portion of the ratchet wrench, and the grip 7 has a big diameter, thicker than the outer layer 2. So the grip 7 needs much material, and a finished grip 7 may not have the needed size because injecting speed and pressure of the material for the grip 7 may be insufficient. Further, the larger the volume of the material, the longer the time for molding, so productive speed may be slow, in addition to low percentage of qualified products.

Next, the metal strip 1 and the outer layer 2 in the conventional ratchet wrench are made with a single mold, so one mold can be used for only one kind of product. Then makers will be forced to make a new mold, if a customer asks a ratchet wrench of a different shape or size, complicating manufacturing processes for makers, who are compelled to prepare many molds for different ratchet wrenches. In view of the most ratchet wrenches seen in the market being only different in the grip 7, and if a new mold is needed to make a ratchet wrench of a different grip, it is not economical for manufacturing.

### SUMMARY OF THE INVENTION

The feature of the ratchet wrench in the invention is a metal rod member, an outer layer and a grip, and metal rod member is provided with a head formed in an upper section and a hollow formed in the head for receiving a ratchet therein, and a rod extending down from the head. The outer layer made of soft material surrounds the head and an upper portion of the rod, with a lower portion of the rod is not surrounded by the outer layer so that the lower portion of the rod may be combined with the grip. The grip is made of plastic, having a gripping surface formed in an intermediate portion of the grip, and a thickness a little larger than that of the outer layer surrounding the upper portion of the rod. Further, the grip is provided with a lengthwise center hollow for receiving the lower portion of the rod therein. Then after the grip is combined with the lower portion of the rod, the lower end of the outer layer contacts with an upper end of the grip. Thus, the grip and the outer layer are small in the dimensions, easier for making separately by means of injecting molding. Moreover, a wide variety of grips can be made with a variety of molds for customers to choose from to match the outer layer together with the metal rod member.

### BRIEF DESCRIPTION OF DRAWINGS

This invention will be better understood by referring to the accompanying drawings, wherein:

FIG. 1 is a cross-sectional view of a conventional ratchet wrench;

FIG. 2 is a perspective view of a first embodiment of a ratchet wrench in the present invention;

FIG. 3 is an exploded perspective view of the fi r s t embodiment of a ratchet wrench in the present invention;

FIG. 4 is a partial cross-sectional view of the first embodiment of a ratchet wrench in the present invention;

FIG. 5 is an exploded perspective view of a second embodiment of a ratchet wrench in the present invention;

FIG. 6 is a front view of another outer layer and another grip in the present invention;

FIG. 7 is a front view of another outer layer and another grip in the present invention;

FIG. 8 is a perspective view of another separating ring in the present invention;

FIG. 9 is a front view of another grip in the present invention; and,

FIG. 10 is a partial cross-sectional view of a third embodiment of a ratchet wrench in the present invention.

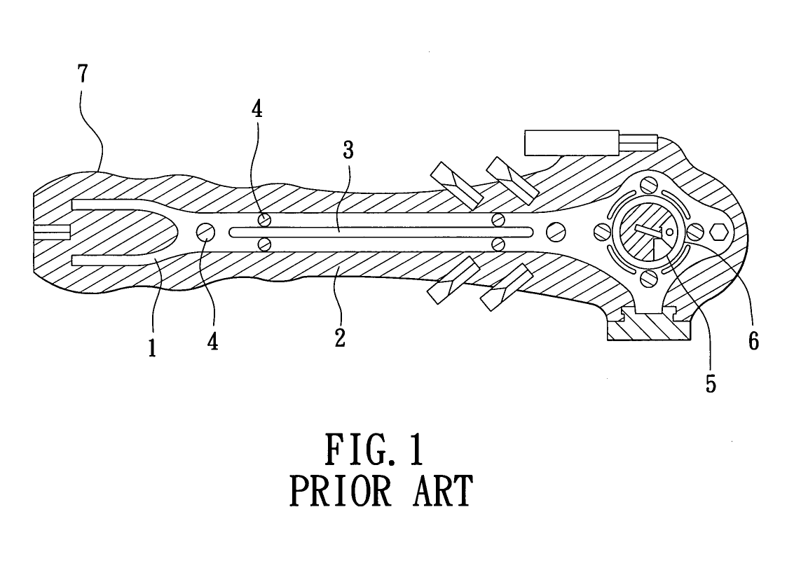

### DETAILED DESCRIPTION OF THE PREFERRED EMBODIMENTS

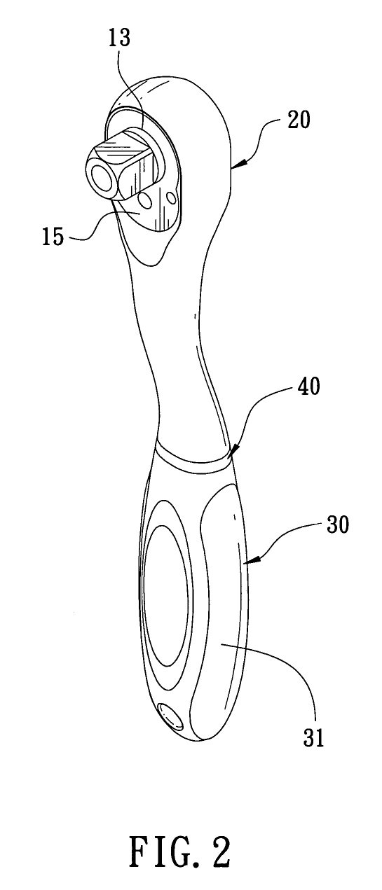

A first embodiment of ratchet wrench in the present invention, as shown in FIGS. 2, 3 and 4, includes a metal rod member 1, an outer layer 20, a grip 30 and a secarating ring 4.

The metal rod member 10 has a head 11 formed in an upper section, a hollow space 12 formed in the head 11 for receiving a ratchet 13 therein, and a rod 14 extending down from the head 11 and having a nearly oval cross-section.

The outer layer 20 is made of soft plastic by means of injecting molding process, surrounding the head 11 and a front portion of the rod 1 4, and a lower portion 141 of the rod 14 not surrounded by the outer layer 20 for fitting in the grip 30. The hollow space 12 has an opening 121 and the outer layer 20 has a hole corresponding to the opening 121 for the ratchet 13 to fit therein to be set with the rod member 10. Further, a cap 15 closes on the hole of the outer layer 20, which has an end edge 21 at a lower end.

The grip 30 is made of plastic and shaped as preset, having a gripping surface 31 formed in an intermediate portion for a hand to grip, and a same thickness as that of the outer layer 20. However, the grip 30 can also be made of two kinds of plastic mixed, so the gripping surface 31 may have gripping effect of two different materials. Further, the grip 30 has a lengthwise center hollow 32 with an opening 321 in an upper end for the lower portion 141 of the rod 14 to fit therein, with the end edge 21 fitting with the opening 321 for closing it up.

The separating ring 40 is elastic, fitted tightly around the end edge 21 of the outer layer 20 at the front end of the grip 30 for making the connection part of the rod member 14 and the grip 30 close and pretty. In addition, the separating ring 40 can be colored black, rod, or yellow to match with the whole appearance for users to select.

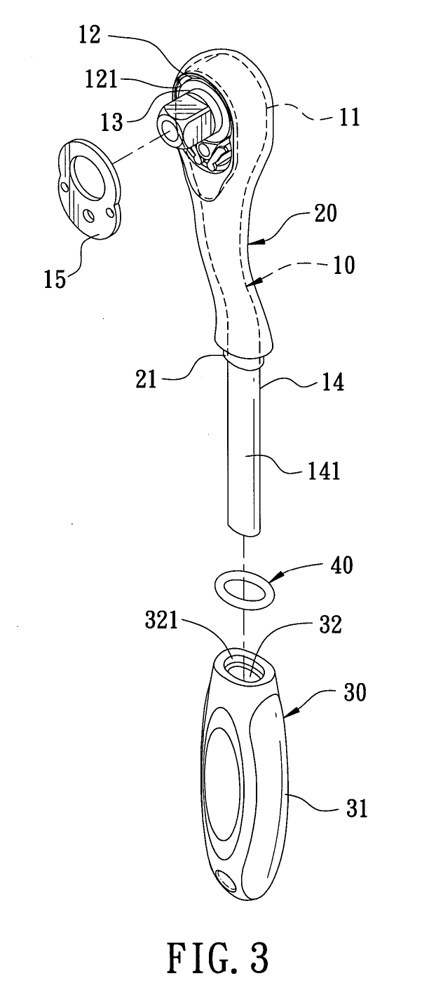

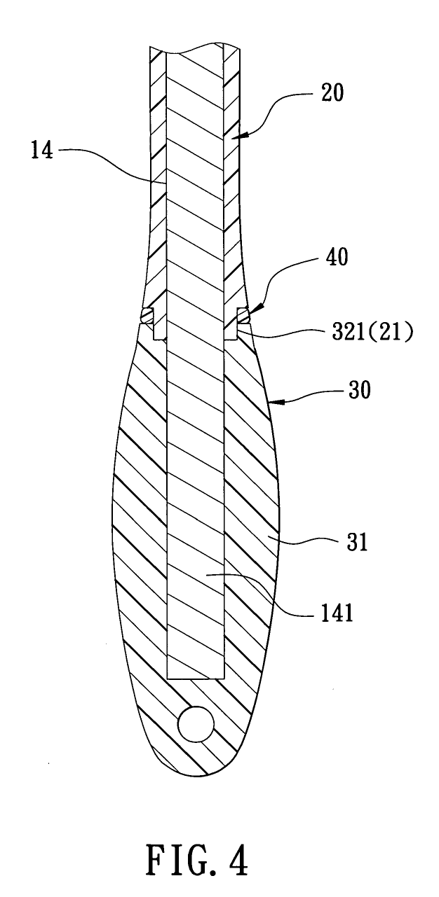

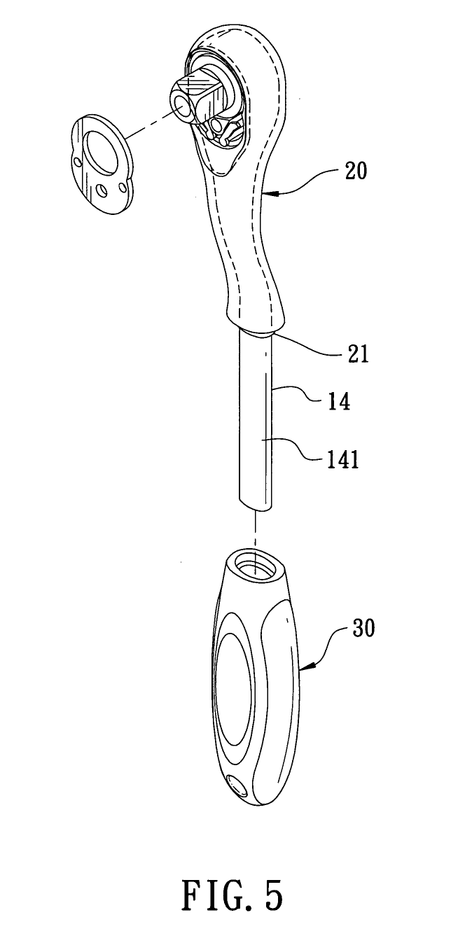

Referring to FIGS. 3 and 4, as the outer layer 20 surrounds the head 11 and the upper portion of the rod 14 for protecting the metal rod member 10, and the thickness of the outer layer 20 are even so that plastic material for the outer layer 20 in a mold may be moved and pressured evenly and formed with high qualified percentage of finished products. Moreover, the grip 30 has the gripping member 31 comparatively thick, but its length is short, it can be formed in an independent mold wherein small mass of the material needed is easily controlled in molding speed and pressure to get high qualified percentage of finished products. Therefore, makers can prepare plural molds for the grips 30, needless of a large mold needed for the conventional ratchet wrench having the metal rod together with the grip, saving largely the expenditure for the molds. Thus, various requirements of customers can be satisfied by supplying a large variety of grips 30 to match with the metal rod 10 together with the outer layer 20 for customers to choose from.

Next, the separating ring 40 can be made to have different colors for customers to choose from, and for benefit of managing and identifying the ratchet wrenches for marketing.

However, the separating ring 40 can also be omitted to let the grip 30 directly contact the lower end of the outer layer 20, still obtaining close mutual combination with the outer layer 20 and grip 30.

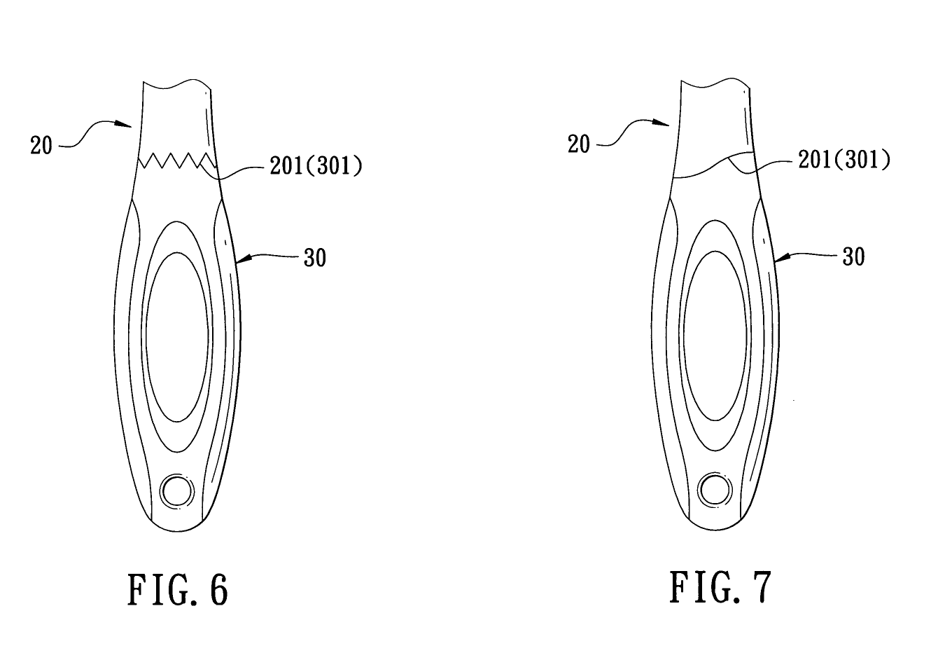

In addition, FIG. 6 shows another embodiment of the outer layer 20 and the grip 30, wherein the lower end of the outer layer 20 is saw-toothed and the upper end of the grip 30 is also saw-toothed to fit closely with that of lower end of the outer layer 20. Further, FIG. 7 shows one more embodiment of the outer layer 20 and the grip 30, wherein the lower end of the outer layer 20 and the upper end of the grip 30 are both shaped as waved one 203 and 302 to fit closely with each other, giving different outer appearance to the ratchet wrench.

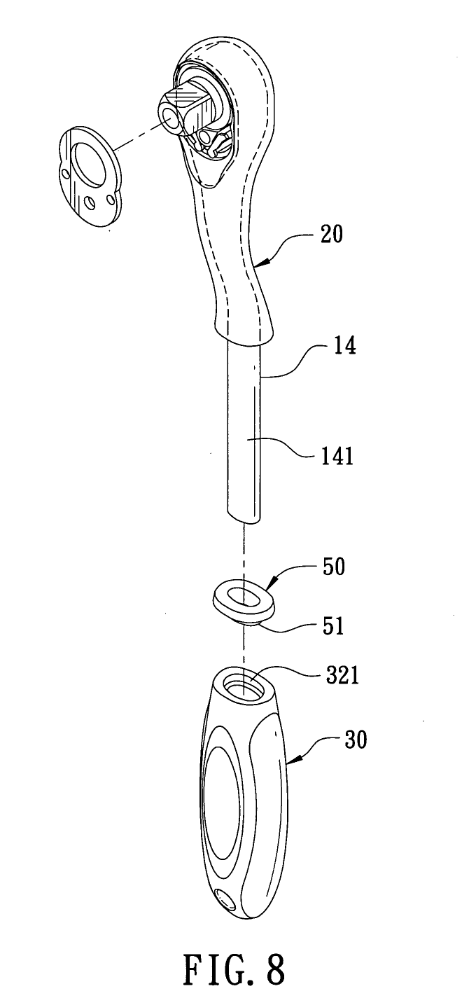

Next, FIG. 8 shows another embodiment of a separating ring 50, wherein the separating ring 50 has some elasticity, a different shape from that of the first embodiment, and a projecting edge 51 on a lower surface to fit in the opening 321 of the center hollow 32 of the grip 30, and an upper flat surface to fit with a flat lower end surface of the outer layer 20 after inserted through the lower portion 141 of the rod 14.

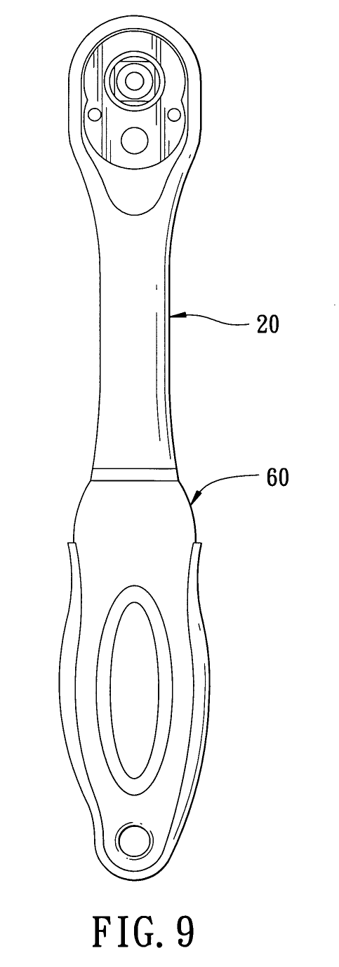

FIG. 9 shows another embodiment of a grip 60 to match with the other components of the ratchet wrench, offering various shapes of a ratchet wrench.

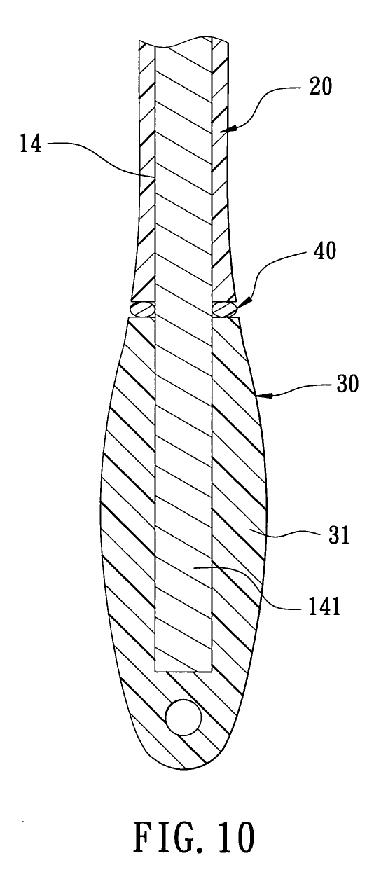

Next, FIG. 10 shows a third embodiment of a ratchet wrench in the invention, which has almost the same structure as the first and the second embodiment, except that the lower end of the outer layer 20 is fitted around directly with the separating ring 30, and then the lower portion 141 of the rod 14 is inserted in the grip 30, speeding assemblage of the ratchet wrench.

Lastly, the invention has the following advantages as can be seen from the foresaid description.

1. The outer layer and the grip are separately made by injection molding process, enhancing the percentage of qualified finished products, increasing injecting molding speed, enhancing producing speed, and lowering producing cost.

2. The grip can be made to have various shapes and colors to match the rod member and the outer layer, offering a large variety of ratchet wrenches for customers to choose from, very beneficial to compete in the market.

3. The outer layer of the ratchet wrench can protect it from hurting a work, prevent it from generating static electricity and offer soft touch for gripping as well.

What is claimed is:

1. A ratchet wrench comprising;
a metal rod member having a head formed in an upper section and a rod extending down from said head, said head having a larger thickness than said rod, a hollow provided in said head for receiving a ratchet therein;
an outer layer made of plastic and surrounding said head and an upper portion of said rod, a lower portion of said rod not surrounded by said outer layer, said outer layer having an opening corresponding to said hollow of said head;
a grip made of plastic and having a preset shape and a gripping surface in an intermediate portion, said grip having a thickness a little larger than that of said outer layer surrounding said upper portion of said rod, said grip further having a lengthwise center hollow for said lower portion of said rod to fit therein firmly, said grip having an upper end contacting with a lower end of said outer layer.

2. The ratchet wrench as claimed in claim 1, wherein a separating ring is fitted between said lower end of said outer layer and said upper end of said grip, and said separating rind is colored for beautifying a connecting part of said outer layer and said grip.

3. The ratchet wrench as claimed in claim 2, wherein said separating ring is 0-shaped, having some preset elasticity.

4. The ratchet wrench as claimed in claim 1, wherein a separating ring is placed between said lower end of said outer layer and said upper end of said grip, said separating ring has a recessed groove in an upper surface to fit said lower end of said outer layer, and a contact edge of a small diameter in a lower end to fit with an opening of said lengthwise center hollow of said grip, and said separating ring is colored, beautifying a connecting part of said outer layer and said grip.

5. The ratchet wrench as claimed in claim 1, wherein said outer layer has said lower end further formed with a projecting contact edge to fit in an opening in said upper end of said grip for reinforcing combination of said outer layer with said grip.

6. The ratchet wrench as claimed in claim 1, wherein a colored separating ring is placed between said lower end of said outer layer and said upper end of said grip for beautifying a connecting part of said outer layer and said grip.

7. The ratchet wrench as claimed in claim 1, wherein said lower end of said outer layer is shaped saw-toothed, and said upper end of said grip is shaped also saw-toothed to fit closely with said saw-toothed upper end of said outer layer.

8. The ratchet wrench as claimed in claim 1, wherein said lower end of said outer layer is shaped waved, and said upper end of said grip is also shaped waved to fit closely with said waved upper end of said outer layer.
